(19) United States
(12) Patent Application Publication
(10) Pub. No.: US 2024/0311381 A1
(43) Pub. Date: Sep. 19, 2024

(54) Using Metadata to Drive Batch and Real-Time Processing in Data Processing Systems

(71) Applicant: Ab Initio Technology LLC, Lexington, MA (US)

(72) Inventors: Marshall A. Isman, Newton, MA (US); Jonah Egenolf, Winchester, MA (US)

(21) Appl. No.: 18/491,601

(22) Filed: Oct. 20, 2023

Related U.S. Application Data
(60) Provisional application No. 63/490,895, filed on Mar. 17, 2023.

(51) Int. Cl. G06F 16/2457; G06F 16/22; G06F 16/23

(52) U.S. Cl. CPC G06F 16/24573; G06F 16/2282; G06F 16/2358

(57) ABSTRACT

Described are techniques for causing a data processing system to perform real-time decisioning by generating a record (e.g., dynamic record) based on a request for the real-time decisioning, wherein the record (e.g., dynamic record) includes batch data and real-time data retrieved from one or more operational systems responsive to receipt of the request, with real-time being with regard to when the request is received by the data processing system.

### CLAIM OF PRIORITY

This application claims priority under 35 U.S.C. § 119(e) to U.S. Patent Application Ser. No. 63/490,895, filed on Mar. 17, 2023, the entire contents of which are hereby incorporated by reference.

### BACKGROUND

This invention relates to data processing systems.

Modern data processing systems manage vast amounts of data within an enterprise. A large institution, for example, may have millions of datasets. These datasets can support multiple aspects of the operation of the enterprise. Complex data processing systems typically process data in multiple stages, with the results produced by one stage being fed into the next stage. The overall flow of data through such systems may be described in terms of a directed dataflow graph, with nodes or vertices in the graph representing components (either data files or processes), and the links or “edges” in the graph indicating flows of data between the components. A system for executing such graph-based computations is described in U.S. Pat. No. 5,966,072, titled “Executing Computations Expressed as Graphs,” incorporated herein by reference.

Graphs also can be used to invoke computations directly. Graphs made in accordance with this system provide methods for getting data and/or information into and out of individual processes represented by graph components, for moving data and/or information between the processes, and for defining a running order for the processes. Systems that invoke these graphs include algorithms that choose inter-process communication methods and algorithms that schedule process execution, and also provide for monitoring of the execution of the graph.

To support a wide range of functions, a data processing system may execute applications, whether to implement routine processes or to extract insights from the datasets. The applications may be programmed to access the data stores to read and write data.

### SUMMARY

In a general aspect 1, described is a method implemented by a data processing system for performing real-time decisioning by generating a dynamic data record based on a request for the real-time decisioning, wherein the dynamic data record includes batch data and real-time data retrieved from one or more operational systems responsive to receipt of the request, with real-time being with regard to when the request is received by the data processing system, including: receiving a request for the dynamic data record associated with a given key; retrieving, from a repository of the data processing system, one or more first values of one or more first fields identified as being one or more batch fields that are retrieved in batch from one or more operational systems, with the one or more retrieved first values being associated with the given key; in response to receiving the request, requesting, from the one or more operational systems, one or more second values of one or more second fields identified as being one or more real-time fields that are retrieved in real-time from the one or more operational systems, with the requested one or more second values being associated with the given key; receiving, from the one or more operational systems, the requested one or more second values associated with the given key; generating the requested data record for the given key, with the data record including: the one or more first values of the one or more first fields identified as being the one or more batch fields, and the one or more second values of the one or more second fields identified as being the one or more real-time fields; applying one or more rules to the generated data record, including determining whether one or more conditions of the one or more rules are satisfied at least partly based on the one or more second values of the one or more second fields identified as being the one or more real-time fields and the one or more first values; based on application of the one or more rules, determining whether to instruct an external system to perform, for the given key, one or more actions specified by the one or more rules; writing to memory the generated data record; and modifying one or more data systems stored in memory with data specifying whether instructions were sent.

In an aspect 2 according to aspect 1, including: reading, from memory, a table with cells specifying fields as batch fields and fields as real-time fields, and responsive to reading, transmitting one or more signals to one or more operational systems, with the one or more signals specifying requests.

In an aspect 3 according to any one of aspects 1 to 2, further including: determining, from a metadata repository, that the one or more first fields are identified as being the one or more batch fields.

In an aspect 4 according to any one of aspects 1 to 3, wherein a batch field is a field that is likely to change with a first frequency and the real-time field is a field that is likely to change with a second frequency which is higher than the first frequency.

In an aspect 5 according to any one of aspects 1 to 4, wherein a batch field is a field that is updated intermittently and/or at pre-determined times.

In an aspect 6 according to any one of aspects 1 to 5, wherein a real-time field is a field that is updated in real-time.

In an aspect 7 according to any one of aspects 1 to 6, wherein the real-time data record is generated only in response to receipt of the request for the dynamic data record.

In an aspect 8 according to any one of aspects 1 to 7, wherein the requested one or more second values are received from the operational systems only in response to receipt of the request for the dynamic data record.

In an aspect 9 according to any one of aspects 1 to 8, wherein the only data requested and/or received from the operational systems for the generating of the requested data record for the given key is the requested one or more second values being associated with the given key.

In an aspect 10 according to any one of aspects 1 to 9, further including: responsive to the request, determining, from a metadata repository, that the one or more second fields are identified as being the one or more real-time fields.

In an aspect 11 according to any one of aspects 1 to 10, further including: retrieving, from the one or more operational systems, a plurality of values of the one or more first fields identified as being the one or more batch fields, with the plurality of values being associated with a plurality of keys, with the plurality of values including the one or more first values and with the plurality of keys including the given key.

In an aspect 12 according to any one of aspects 1 to 11, further including: storing, in the repository of the data processing system, the plurality of values in association with the plurality of keys.

In a general aspect 13, a data processing system including for performing real-time decisioning by generating a dynamic data record based on a request for the real-time decisioning, wherein the dynamic data record includes batch data and real-time data retrieved from one or more operational systems responsive to receipt of the request, with real-time being with regard to when the request is received by the data processing system, including: one or more processing devices, and one or more machine-readable hardware storage devices storing instructions that are executable by the one or more processing devices to perform operations including: receiving a request for the dynamic data record associated with a given key; retrieving, from a repository of the data processing system, one or more first values of one or more first fields identified as being one or more batch fields that are retrieved in batch from one or more operational systems, with the one or more retrieved first values being associated with the given key; in response to receiving the request, requesting, from the one or more operational systems, one or more second values of one or more second fields identified as being one or more real-time fields that are retrieved in real-time from the one or more operational systems, with the requested one or more second values being associated with the given key; receiving, from the one or more operational systems, the requested one or more second values associated with the given key; generating the requested data record for the given key, with the data record including: the one or more first values of the one or more first fields identified as being the one or more batch fields, and the one or more second values of the one or more second fields identified as being the one or more real-time fields; applying one or more rules to the generated data record, including determining whether one or more conditions of the one or more rules are satisfied at least partly based on the one or more second values of the one or more second fields identified as being the one or more real-time fields and the one or more first values; based on application of the one or more rules, determining whether to instruct an external system to perform, for the given key, one or more actions specified by the one or more rules; writing to memory the generated data record; and modifying one or more data systems stored in memory with data specifying whether instructions were sent.

In an aspect 14 according to aspect 13, the operations further include: reading, from memory, a table with cells specifying fields as batch fields and fields as real-time fields, and responsive to reading, transmitting one or more signals to one or more operational systems, with the one or more signals specifying requests.

In an aspect 15 according to any one of aspects 13 to 14, further including: determining, from a metadata repository, that the one or more first fields are identified as being the one or more batch fields.

In an aspect 16 according to any one of aspects 13 to 15, wherein a batch field is a field that is likely to change with a first frequency and the real-time field is a field that is likely to change with a second frequency which is higher than the first frequency.

In an aspect 17 according to any one of aspects 13 to 16, wherein a batch field is a field that is updated intermittently and/or at pre-determined times.

In an aspect 18 according to any one of aspects 13 to 17, wherein a real-time field is a field that is updated in real-time.

In an aspect 19 according to any one of aspects 13 to 18, wherein the real-time data record is generated only in response to receipt of the request for the dynamic data record.

In an aspect 20 according to any one of aspects 13 to 19, wherein the requested one or more second values are received from the operational systems only in response to receipt of the request for the dynamic data record.

In an aspect 21 according to any one of aspects 13 to 20, wherein the only data requested and/or received from the operational systems for the generating of the requested data record for the given key is the requested one or more second values being associated with the given key.

In an aspect 22 according to any one of aspects 13 to 21, wherein the operations further include responsive to the request, determining, from a metadata repository, that the one or more second fields are identified as being the one or more real-time fields.

In an aspect 23 according to any one of aspects 13 to 22, wherein the operations further include retrieving, from the one or more operational systems, a plurality of values of the one or more first fields identified as being the one or more batch fields, with the plurality of values being associated with a plurality of keys, with the plurality of values including the one or more first values and with the plurality of keys including the given key.

In an aspect 24 according to any one of aspects 13 to 23, wherein the operations further include storing, in the repository of the data processing system, the plurality of values in association with the plurality of keys.

In a general aspect 25, one or more machine-readable hardware storage devices for performing real-time decisioning by generating a dynamic data record based on a request for the real-time decisioning, wherein the dynamic data record includes batch data and real-time data retrieved from one or more operational systems responsive to receipt of the request, with real-time being with regard to when the request is received by the data processing system, the one or more machine-readable hardware storage devices storing instructions that are executable by one or more processing devices to perform operations including: receiving a request for the dynamic data record associated with a given key; retrieving, from a repository of the data processing system, one or more first values of one or more first fields identified as being one or more batch fields that are retrieved in batch from one or more operational systems, with the one or more retrieved first values being associated with the given key; in response to receiving the request, requesting, from the one or more operational systems, one or more second values of one or more second fields identified as being one or more real-time fields that are retrieved in real-time from the one or more operational systems, with the requested one or more second values being associated with the given key; receiving, from the one or more operational systems, the requested one or more second values associated with the given key; generating the requested data record for the given key, with the data record including: the one or more first values of the one or more first fields identified as being the one or more batch fields, and the one or more second values of the one or more second fields identified as being the one or more real-time fields; applying one or more rules to the generated data record, including determining whether one or more conditions of the one or more rules are satisfied at least partly based on the one or more second values of the one or more second fields identified as being the one or more real-time fields and the one or more first values; based on application of the one or more rules, determining whether to instruct an external system to perform, for the given key, one or more actions specified by the one or more rules; writing to memory the generated data record; and modifying one or more data systems stored in memory with data specifying whether instructions were sent.

In an aspect 26 according to aspect 25, wherein the operations further include reading, from memory, a table with cells specifying fields as batch fields and fields as real-time fields, and responsive to reading, transmitting one or more signals to one or more operational systems, with the one or more signals specifying requests.

In an aspect 27 according to any one of aspects 25 to 26, wherein the operations further include determining, from a metadata repository, that the one or more first fields are identified as being the one or more batch fields.

In an aspect 28 according to any one of aspects 25 to 27, wherein a batch field is a field that is likely to change with a first frequency and the real-time field is a field that is likely to change with a second frequency which is higher than the first frequency.

In an aspect 29 according to any one of aspects 25 to 28, wherein a batch field is a field that is updated intermittently and/or at pre-determined times.

In an aspect 30 according to any one of aspects 25 to 29, wherein a real-time field is a field that is updated in real-time.

In an aspect 31 according to any one of aspects 25 to 30, wherein the real-time data record is generated only in response to receipt of the request for the dynamic data record.

In an aspect 32 according to any one of aspects 25 to 31, wherein the requested one or more second values are received from the operational systems only in response to receipt of the request for the dynamic data record.

In an aspect 33 according to any one of aspects 25 to 32, wherein the only data requested and/or received from the operational systems for the generating of the requested data record for the given key is the requested one or more second values being associated with the given key.

In an aspect 34 according to any one of aspects 25 to 33, wherein the operations further include responsive to the request, determining, from a metadata repository, that the one or more second fields are identified as being the one or more real-time fields.

In an aspect 35 according to any one of aspects 25 to 34, wherein the operations further include retrieving, from the one or more operational systems, a plurality of values of the one or more first fields identified as being the one or more batch fields, with the plurality of values being associated with a plurality of keys, with the plurality of values including the one or more first values and with the plurality of keys including the given key.

In an aspect 36 according to any one of aspects 25 to 35, wherein the operations further include storing, in the repository of the data processing system, the plurality of values in association with the plurality of keys.

In an aspect 37, a data processing system includes means for carrying out the method of any one of the preceding claims and/or aspects.

In an aspect 38, a computer program product tangibly stored on a non-transitory computer readable medium, for causing a data processing system to perform the method of any one of the preceding claims and/or aspects.

According to preferred aspects, from a schema definition, the data processing system can generate a record (e.g., wide record) with all data joined together based on relationships. A user can annotate places in the schema for special rollups. Many different records (e.g., wide records) can be generated based on which area of the schema is desired (i.e., customer, transaction, . . . ). Batch fields may likely be updated and/or changed less frequently than real-time fields. Batch fields may be updated and/or changed intermittently and/or at predetermined times. Real-time fields may be updated and/or changed in real-time. Batch fields may be stored in persistent storage. Real-time fields may be stored in volatile memory.

Aspects of the techniques described herein reduce latency and/or memory resources in providing requested records (e.g., data records), while increasing computational efficiency in doing so. This is because the techniques described herein only update records on-demand, e.g., responsive to a request. As such, the techniques described herein do not waste resources updating record that will never be used.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1A is a block diagram of a system including a data processing system that includes a real-time integrator.

FIG. 1A-1 is a legend for FIG. 1A.

FIG. 1B is a block diagram of the system of FIG. 1A showing a record (e.g., wide record).

FIG. 2 is a block diagram of the system of FIG. 1A showing customer records (e.g., batch and real-time records) and business records (e.g., batch and real-time records).

FIGS. 3A-3C are block diagrams of the system of FIG. 1A showing a real-world example.

FIGS. 4A-4D are block diagrams of the system of FIG. 1A showing another real-world example without batch updating.

FIG. 5 is a graph depicting a timeline of component execution in the system of FIG. 1A.

FIG. 5A is a legend for FIG. 5.

FIG. 6 is a flow diagram depicting a flow of operations for performing a real-time decision by generating a record (e.g., dynamic record) based on a request for the real-time decision.

FIG. 7 is a block diagram of an example of a computing device or a computer or data processing system or client or server.

### DETAILED DESCRIPTION

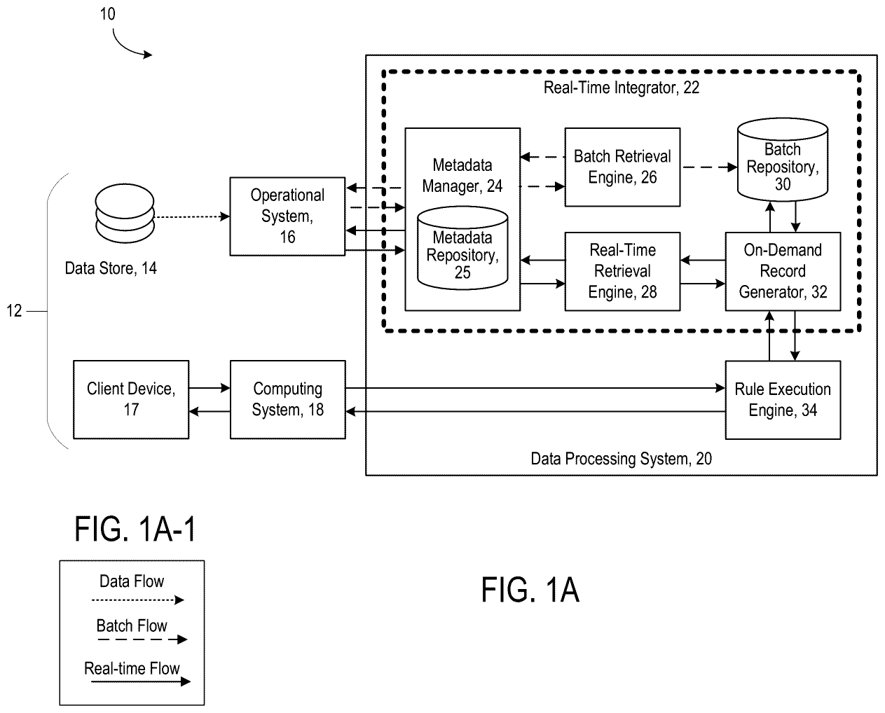

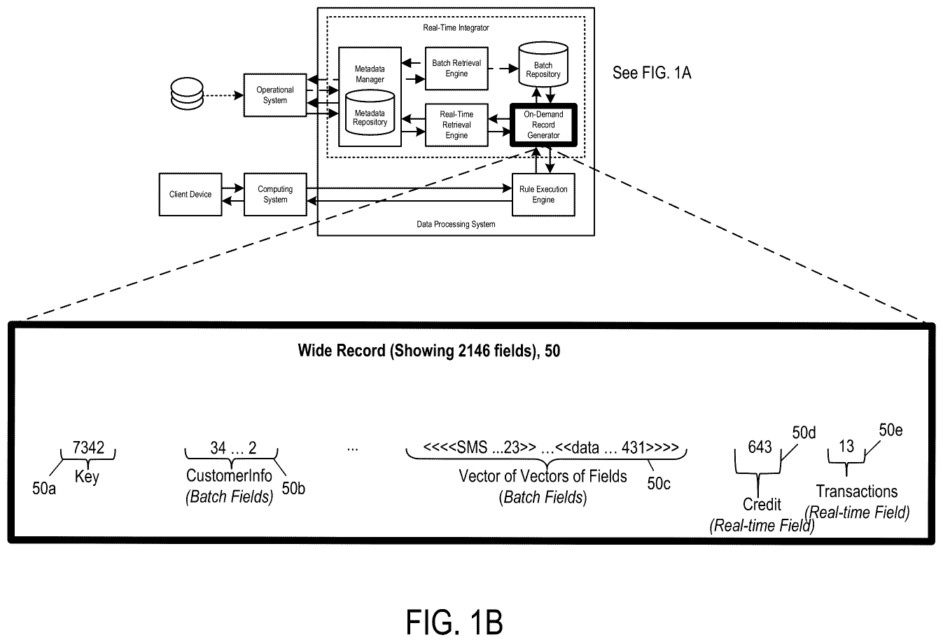

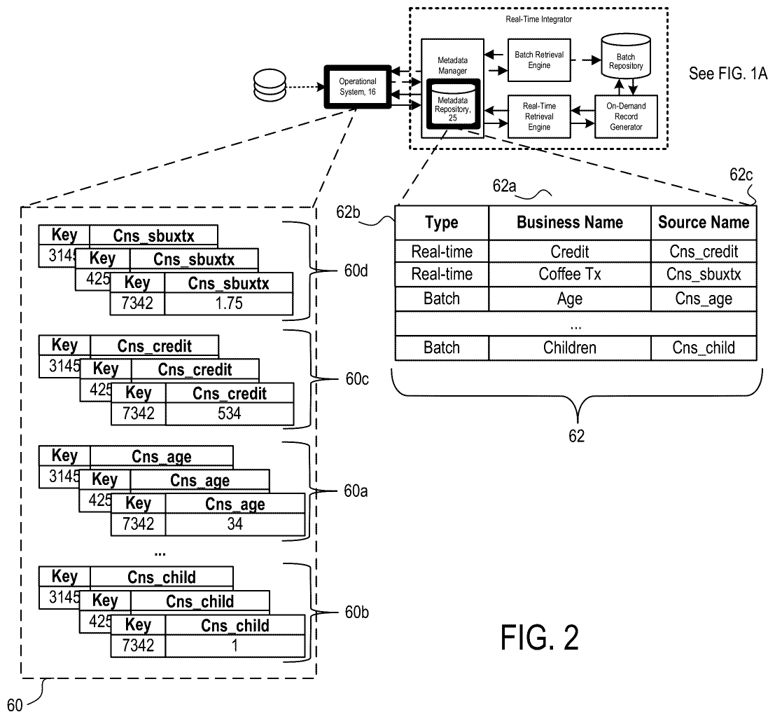

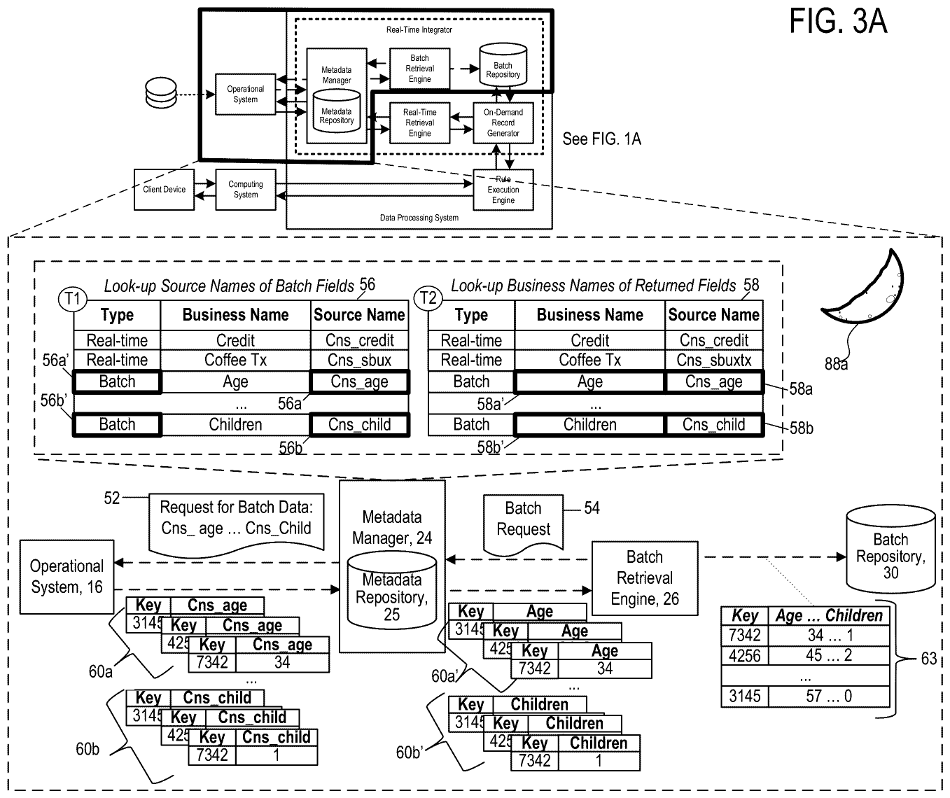

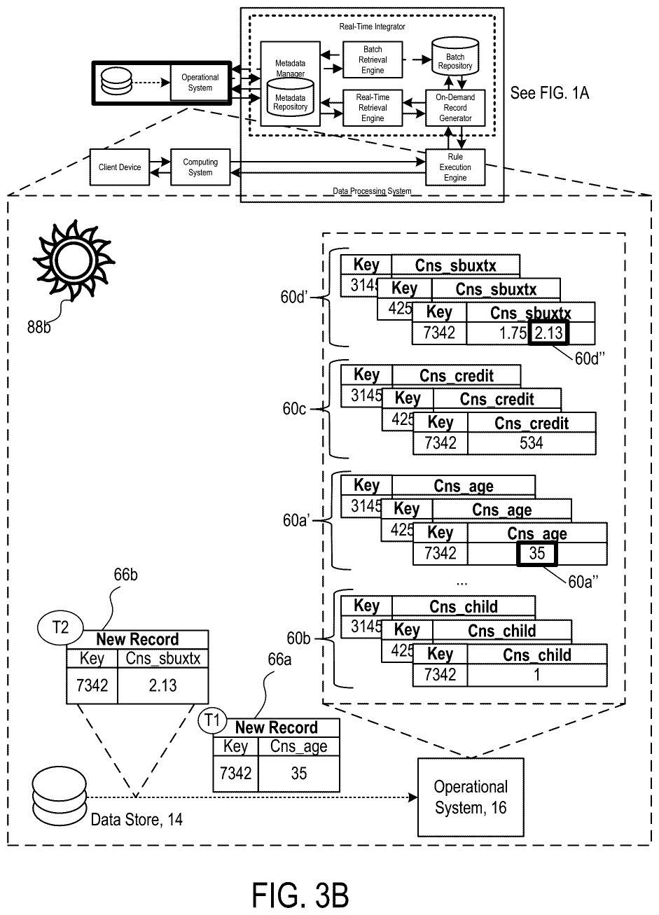

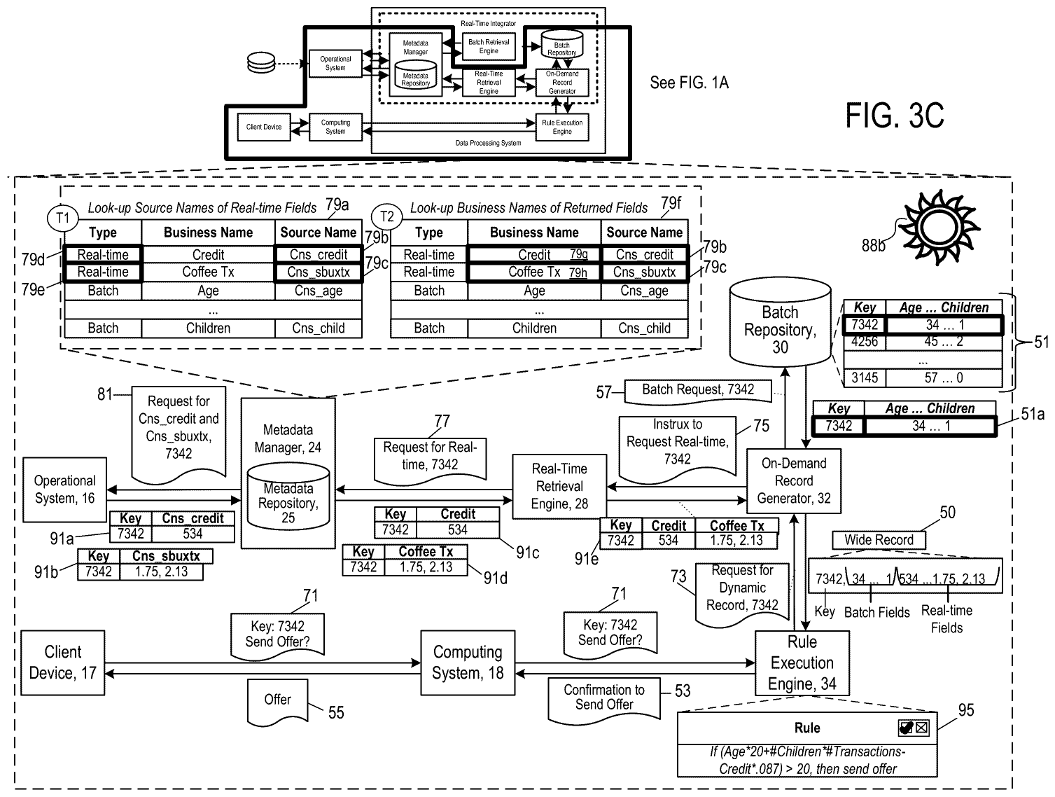

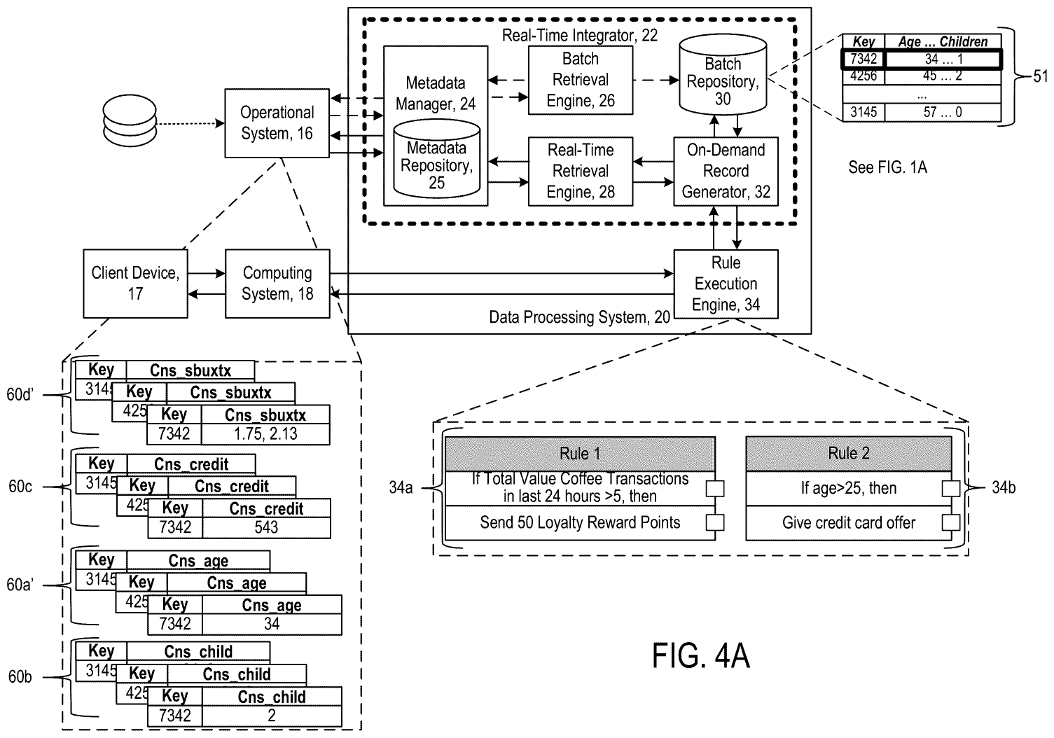

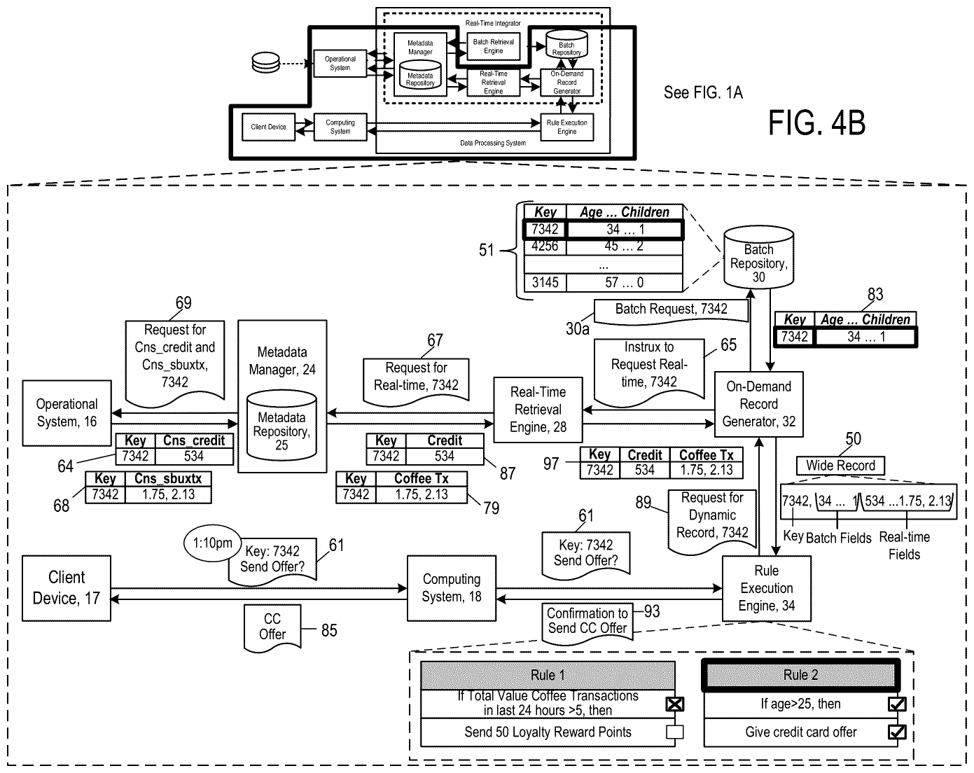

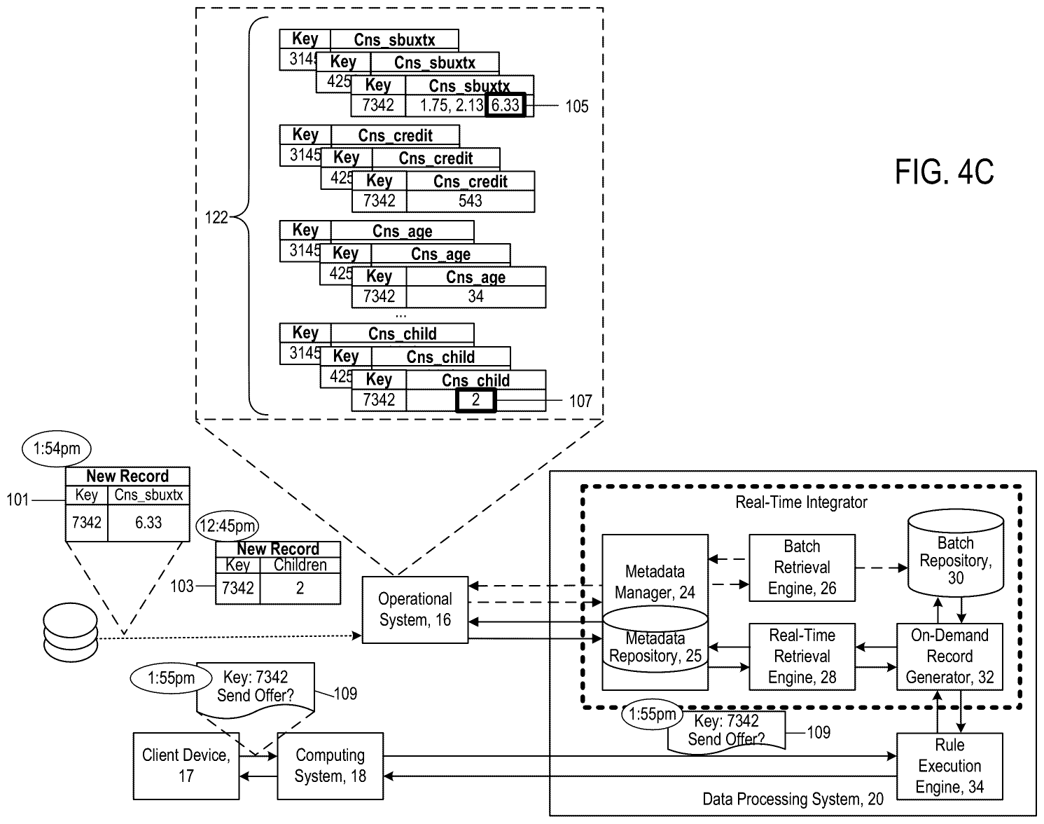

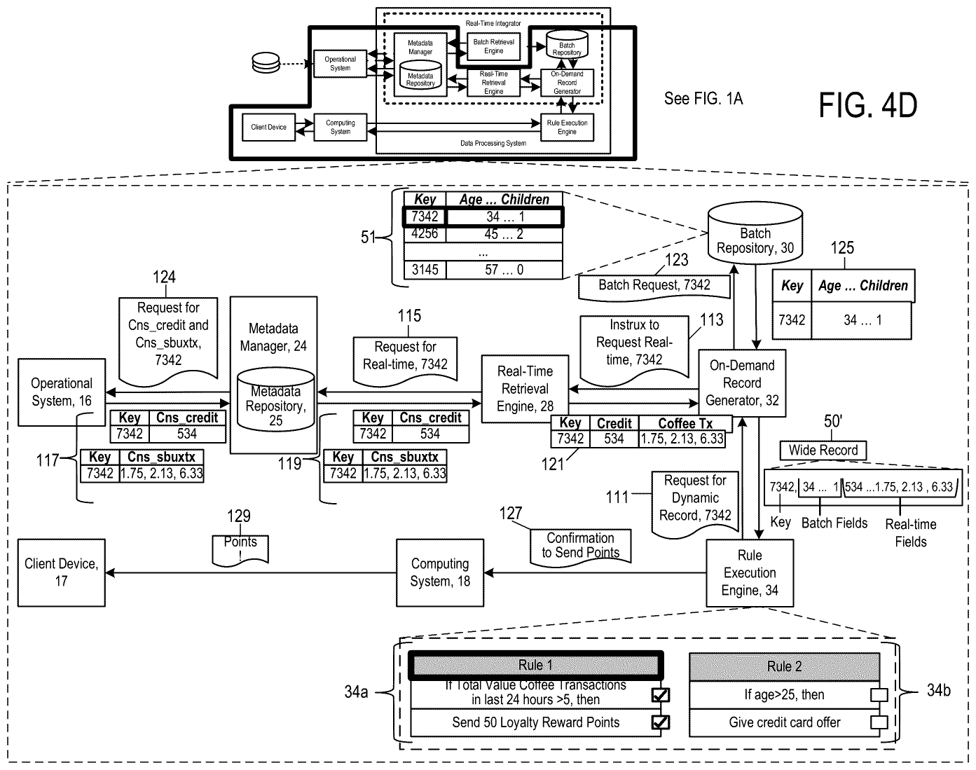

Referring to FIG. 1A-1, a legend for FIG. 1A is shown. Flows in FIG. 1A-1 are represented as follows: A data flow is represented by dotted lines, a batch flow is represented by dashed lines and a real-time flow is represented by solid lines.

Referring now to FIG. 1A, a system 10 is shown. System 10 includes client systems 12 (e.g., customer systems) and a data processing system 20. The client systems 12 includes a data store 14 that stores records (e.g., transaction records), an operational system 16 that communicates with the data processing system 20, a client device 17 that communicates with a computing system 18 that in turn communicates with a rule execution engine 34 in the data processing system 20.

The data processing system 20 includes a real-time integrator 22. The real-time integrator 22 includes a metadata manager 24 and a metadata repository 25. The metadata manager 24 communicates with a batch retrieval engine 26, whereas the metadata repository 25 communicates with a real-time retrieval engine 28. The batch retrieval engine 26 sends batch results of fetching records in batch from operational system 16 (e.g., every night) to a batch repository 30 and the real-time retrieval engine 28 sends real-time results (e.g., of fetching records in real-time from operational system 16) to an on-demand record generator 32. The batch repository 30 and the on-demand record generator 32 are in communication, whereas the on-demand record generator 32 is also in communication with the rule execution engine 34.

Referring now to FIG. 1B, a reduced version of FIG. 1A is shown with the on-demand record generator 32 highlighted. Refer to FIG. 1A, if needed, to identify where the on-demand record generator 32 is placed in relation to other elements of FIG. 1A.

Also shown in FIG. 1B is a record 50 (e.g., wide record) that is generated by the on-demand record generator 32. Record 50 (e.g., wide record) includes numerous fields, including, e.g., fields 50a, 50b . . . 50e. Some of the fields 50a, 50b . . . 50e can be a vector of fields and/or a vector of a vector. In an example, a record (e.g., wide record) includes a data structure that is structured with fields, with each field storing or being associated with a data value.

In this example, the record 50 (e.g., wide record) shows 2146 fields comprising a field 50a storing a key represented by 5 characters, customer information (batch fields) 50b represented by a large plurality of fields, a vector of vectors fields (batch fields) 50c represented by a large plurality of fields, a credit (real-time fields) 50d, and transaction fields (real-time fields) 50e.

Referring now to FIG. 2, the reduced version of FIG. 1A (without illustrating the client device 17, computing system 18 and rule execution engine 34 of FIG. 1A) is shown with the operational system 16 and metadata repository 25 highlighted. Refer to FIG. 1A, if needed, to identify where the operational system 16 and metadata repository 25 are placed in relation to other components of FIG. 1A. The operational system 16 has customer records 60 (four types of records are shown for each of a plurality of keys, with three keys being an example, but could be many more for many more keys) from the data store 14 (FIG. 1A). In this example, customer records 60 includes customer records 60a-60d. The customer records 60 from the operational system 16 has field names that are foreign to field names in the real-time integrator 22. The metadata repository 25 stores in a record 62 business names 62a corresponding to the field names in the customer records 60, a type 62b, e.g., a batch or a real-time type, and source name 62c.

FIGS. 3A-3C show a real-world example.

Referring now to FIG. 3A, the reduced version of FIG. 1A is shown with the operational system 16 and metadata manager 24 highlighted, amongst others. Refer to FIG. 1A, if needed, to identify where the operational system 16 and metadata manager 24 are placed in relation to other components of FIG. 1A.

At a time for batch retrieval, batch retrieval engine 26 transmits batch request 54 to metadata manager 24. In turn, metadata manager 24 looks-up (at time T¹) in table 56 which fields are of a batch type (e.g., updated only intermittently and/or at predetermined times) and the name (e.g., the name as the source for those fields). In this example, metadata manager 24 identifies cells 56a and 56b that contain values of “batch.” Metadata manager 24 looks up the corresponding source names for batch cells 56a′, 56b′.

In this example, the corresponding source names are in cells 56a, 56b. Using the values in 56a, 56b, metadata manager 24 generates request 52 that specifies the names of the batch fields that metadata manager 24 needs to retrieve from operational system 16.

In turn, operational system 16 returns the records 60a, 60b that include values for fields represented in cells 56a, 56b and corresponding cell values. Records 60a, 60b are returned to metadata manager 24. Metadata manager 24 re-labels the names of the returned fields by looking up (e.g., at time T₂) in table 58 cells 58a, 58b that correspond to the technical field names in records 60a, 60b. Metadata manager 24 then looks up the corresponding cells 58a′, 58b′ with the business names for source names represented in cells 58a, 58b.

The operations discussed in FIG. 3A can occur in off-peak hours, e.g., at night as batch operations, denoted by the symbol 88a. The operational system 16 sends the records 60a, 60b from the data store 14 (FIG. 1A) to the metadata manager 24. The metadata manager 24 looks up source names of batch fields and looks-up business names of returned fields.

In FIG. 3A, batch updating is done intermittently, e.g., once a day and at night. Metadata manager 24 stores table 56 that identifies which fields are batch fields and are therefore only updated, e.g., nightly. That is, operational system 16 stores all data—both real-time and batch. However, data processing system 20 only retrieves the batch data from operational system 16 intermittently and/or at pre-determined times, e.g., once a night. In contrast, real-time data (which will be discussed later with regard to FIG. 3C) is retrieved by data processing system 20 only when a request is received for a record (e.g., real-time record) of events or transactions. For example, values for real-time fields may be retrieved from operational system 16 multiple times a day, but the values for the batch fields are only retrieved once a data. The metadata manager 24 labels fields as real-time or batch depending on the frequency with which that data changes. For example, age and the number of children changes relatively infrequently, compared to the frequency with which a user may make a coffee transaction—which may be 3 or 4 times a day.

In this example, a request is made to the operational system 16 for records (e.g., batch records) related to ‘Cns_age’ to ‘Cns_child.’ The operational system 16 returns three records of different keys (three of which are shown, but could be many more), as shown for ‘Cns_age’ and three records of different keys (three of which are shown, but could be many more) for ‘Cns_child.’ These records are sent to the metadata manager 24 and the metadata manager 24 executes a look up in the metadata repository 25 to produce three records (could be many more) of different keys with business names, ‘age’ and three records of different keys with business names, ‘children.’ The batch retrieval engine 26 receives the three records of different keys with business names, ‘age’ and three records of different keys with business names, ‘children’ and sends to a batch repository 30 records 63 (e.g., concatenated records) of different keys (three of which are shown, but could be many more), as:

| Key | Age | . . . | Children |
|---|---|---|---|
| 7342 | 34 | . . . | 1 |
| 4256 | 45 | . . . | 2 |
| 3145 | 57 | . . . | 0 |

from the three records of different keys with business names, ‘age’ and the three records of different keys with business names, ‘children.’

Referring now to FIG. 3B, the reduced version of FIG. 1A is shown with the operational system 16 (not referenced in FIG. 3B) highlighted. Refer to FIG. 1A, if needed, to identify where the operational system 16 is placed in relation to other components of FIG. 1A. At time T1 a new record 66a is sent to the operational system 16 and at time T2 another, new record 66b is sent to the operational system 16. These are real-time operations and records that occur during peak operation time of the operational system 16, e.g., during day-time operation as denoted by the symbol 88b. The new record 66a updates records 60a to records 60a′, e.g., key 7342 is updated from Cns_age 34 to Cns_age 35 as shown by portion 60a″. Also, the new record 66b updates the records 60d to records 60d′, e.g., key 7342 is updated from Cns_sbuxtx 1.75 to Cns_sbuxtx 1.75, 2.13, as shown by portions 60d″. Other records for key 7342 remain unchanged, e.g., Cns_child and Cns_credit, as shown by records 60b, 60c.

Referring now to FIG. 3C, the reduced version of FIG. 1A is shown (but components are not referenced in FIG. 3C). Refer to FIG. 1A, if needed, to identify where specific components are placed in relation to other components of FIG. 1A. Client device 17 sends a request 71 to the computing system 18. The request 71 in this example is “Key: 7342 send an offer?” Request 71 is a keyed request that includes or otherwise specifies a key (e.g., a unique identifier) of a user associated with client device 17. The computing system 18 receives this request 71 and sends the request 71 to the rule execution engine 34. Computing system 18 may be associated with a bank or with a vendor, and thus receives the request as to whether an offer should be sent. However, computing system 18 itself does not store the logic to identify whether an offer should be sent. The rule execution engine 34 obtains or stores a business rule to determine whether to send client device 17 associated with key 7342 an offer. An example of a business rule 95 is:
“If (Age*20+#Children*#Transactions−Credit*.087)>20, then send offer.”

In order to execute this business rule 95 (or any other business rule) the rule execution engine 34 needs a record (e.g., wide record) of all information associated with key 7342 and rule execution engine 34 needs this information in real-time with regard to when client device 17 sends request 71. To receive this record (e.g., wide record), rule execution engine 34 sends a request 73 to the on-demand record generator 32. Request 73 includes the value of the key. On-demand record generator 32 generates this record (e.g., wide record) responsive to and at the time of receiving the request 73, rather than constantly updating a record for key 7342 with up-to-date information. In this example, on-demand record generator 32 only generates the record (e.g., real-time record) (with real time being with regard to when request 71 is sent) in response to receipt of request 73. The on-demand record generator 32 sends an instruction 75 to request records (e.g., real-time records) for key 7342 to the real-time retrieval engine 28. In response, the real-time retrieval engine 28 sends a request 77 for records (e.g., real-time records) for key 7342 to the metadata manager 24. The metadata manager 24 looks up (at time T1) in table 79a of the metadata repository 25, the source names of real-time fields 79b, 79c of the real-time fields 79d, 79e. The metadata manager 24 sends a request 81 to the operational system 16 for Cns_credit and Cns_sbuxtx (the source names of the real-time fields as looked up), for key 7342 to obtain real-time values for these fields represented by source names of real-time fields 79b, 79c. In some examples, metadata manager 24 sends the request by transmitting one or more signals that specify the requests. The operational system 16 returns the records 91a, 91b, “Key 7342 Cns_credit 534” and “Key 7342 Cns_sbuxtx 1.75, 2.13.” The metadata manager 24 looks up at time T2 in table 79f the business names 79g, 79h of the returned source names of real-time fields 79b, 79c. Metadata manager 24 produces new records 91c, 91d with the business names 79g, 79h and the values specified in the records 91a, 91b for key 7342. Metadata repository 25 returns the new records 91c, 91d, “Key 7342 Credit 534” and “Key 7342 Coffee Tx 1.75, 2.13,” to real-time retrieval engine 28. That is, the records with the business names of returned fields, “Key 7342 Credit 534” and “Key 7342 Coffee Tx 1.75, 2.13,” are sent by the metadata manager 24 to the real-time retrieval engine 28. The real-time retrieval engine 28 produces a record 91e (e.g., concatenated record)—“Key 7342 Credit 534 Coffee Tx 1.75, 2.13.” The real-time retrieval engine 28 transmits record 91e (e.g., concatenated record) to record generator 32 (e.g., on-demand record).

The on-demand record generator 32 sends the record (e.g., concatenated record) “Key 7342 Credit 534 Coffee Tx 1.75, 2.13” to the batch repository 30. The batch repository 30 uses the record (e.g., concatenated record) to retrieve for key 7342 the age and number of children of key 7342 that are sent to the on-demand record generator 32. In another example, on-demand record generator 32 transmits to batch repository 30 a request 57 for entries in lookup table 51 associated with key 7342. In response, batch repository 30 transmits entry 51a to on-demand record generator 32. The on-demand record generator 32 produces a record 50 (e.g., wide record) as:

| | | | |
|---|---|---|---|
| 7342, | 34 . . . 1 | 534 . . . 1.75, | 2.13 |
| Key | Batch Fields | Real-time | Fields |

where the record 50 (e.g., wide record) includes in the batch field for key 7342 the age “34” and the Coffee Tx of “1.75, 2.13.” The rule execution engine 34 executes the business rule 95
“If (Age*20+#Children*#Transactions−Credit*.087)>20, then send offer” for key 7342 and confirms that key 7342 qualifies for an offer. The confirmation 53 is sent to the computing system 18 and the computing system 18 generates the offer 55 that is sent to and received by the client device 17.

FIGS. 4A-4B show a real-world example, without a batch update.

Referring now to FIG. 4A, operational system 16 stores records 60a′ 60b, 60c, 60d′, as previously described. In this example, batch repository 30 stores lookup table 51 as previously described, and as a result of the batch retrieval performed on operational system 16. Rule execution engine 34 stores rules 34a, 34b.

Referring now to FIG. 4B, client device 17 sends (at 1:10 pm) a request 61 to the computing system 18. The request 61 in this example is whether the computing system 18 should send the customer associated with key 7342 an offer. The computing system 18 receives this request 61 and sends the request 61 to the rule execution engine 34. Before the rule execution engine 34 can execute rules, the rule execution engine needs to receive a record (e.g., wide record) of a data associated with key 7342. As described herein, part of the information in the record (e.g., wide record) will be batch data and part of the information will be real-time information. To start the process of receiving the record (e.g., wide record), rule execution engine 34 transmits to on-demand record generator 32 a request for record 89 (e.g., dynamic record). The on-demand record generator 32 sends an instruction 65 to request records (e.g., real-time records) for key 7342 to the real-time retrieval engine 28. The real-time retrieval engine 28 sends a request 67 for records (e.g., real-time records) for key 7342 to the metadata manager 24.

The metadata manager 24 looks up in the metadata repository 25 the source names of the real-time fields, as previously described. The metadata manager 24 sends a request 69 to the operational system 16 for Cns_credit and Cns_sbuxtx, for key 7342 to look up source names for the real-time fields Credit and Coffee Tx. The operational system 16 returns records 64, 68, “Key 7342 Cns_credit 534” and “Key 7342 Cns_sbuxtx 1.75, 2.13.” The metadata manager 24 looks up the business names of the returned fields and the metadata repository 25 returns the records 87, 79, “Key 7342 Credit 534” and “Key 7342 Coffee Tx 1.75, 2.13.” The records 87, 79 with the business names of returned fields, “Key 7342 Credit 534” and “Key 7342 Coffee Tx 1.75, 2.13,” are sent by the metadata manager 24 to the real-time retrieval engine 28. The real-time retrieval engine 28 produces a record 97 (e.g., concatenated record), “Key 7342 Credit 534 Coffee Tx 1.75, 2.13.”

The on-demand record generator 32 sends batch request 30a (or the record 97 (e.g., concatenated record) “Key 7342 Credit 534 Coffee Tx 1.75, 2.13”) to the batch repository 30. The batch repository 30 uses the record 97 (e.g., concatenated record) to retrieve record 83 for “Key 7342” (e.g., the age “34” and children “1” of Key 7342), which are sent to the on-demand record generator 32. Using record 83 and record 97 (e.g., concatenated record), the on-demand record generator 32 produces a record 50 (e.g., wide record) as:

| | | | |
|---|---|---|---|
| 7342, | 34 . . . 1 | 534 . . . 1.75, | 2.13 |
| Key | Batch Fields | Real-time | Fields |

In this example, the real-time fields are retrieved in response to request 61. That is, the real-time fields are retrieved in real-time, with regard to when the request 61 is received. In contrast, batch fields have previously been retrieved from operational system 16, e.g., at a time specified for batch retrieval. The batch fields are retrieved from batch repository 30, e.g., as shown in first entry of table 51. The rule execution engine 34 executes the business rule
“If Total Value Coffee Transactions in last 24 hours >5, then Send 50 Loyalty Reward Points,” for key 7342 and does not confirm that key 7342 qualifies for the 50 Loyalty Reward Points offer. The non-confirmation is sent to the computing system 18 and the computing system 18 does not generate the offer.

Next, FIG. 4B tests Rule 2,
“If age>25, then Give credit card offer.”
   In this example the customer is 34 years old and the rule execution engine 34 executes the business rule to determine that the key 7342 qualifies for the credit card offer. The confirmation 93 is sent to the computing system 18 and the computing system 18 generates the offer 85 that is sent to the client device 17.

FIGS. 4C-4D show a second real-world example, without a batch update by batch retrieval engine 26.

Referring now to FIG. 4C, the operational system 16 receives new records, a record 101 (e.g., transaction record) at 1:54 pm and record 103 (e.g., children record) at 12:45 pm. In response, operational system 16 updates its database and records (e.g., data records), as shown in portions 105 and 107 of records 122 (e.g., data records).

At 1:55 pm, the client device 17 sends a request 109 to the computing system 18. The request in this example is whether the customer should receive an offer. As such, request 109 specifies “Key: 7342 send offer?” In this example, request 109 is keyed to specify the user for which an offer may possibly be sent. The computing system 18 receives this request 109 and sends the request “Key: 7342 send offer?” to the rule execution engine 34.

Referring now to FIG. 4D, the rule execution engine 34 sends a request 111 to the on-demand record generator 32. The on-demand record generator 32 sends an instruction 113 to request records (e.g., real-time records) for key 7342 to the real-time retrieval engine 28. The real-time retrieval engine 28 sends a request 115 for records (e.g., real-time records) for key 7342 to the metadata manager 24. The metadata manager 24 looks up in the metadata repository 25 the source names of the real-time fields. The metadata manager 24 sends a request 124 to the operational system 16 for Cns_credit and Cns_sbuxtx, for key 7342 to look up source names for the real-time fields Credit and Coffee Tx. The operational system 16 returns records 117, “Key 7342 Cns_credit 534” and “Key 7342 Cns_sbuxtx 1.75, 2.13, 6.33.” The metadata manager 24 looks up the business names of the returned fields and the metadata repository 25 returns the records 119, “Key 7342 Credit 534” and “Key 7342 Coffee Tx 1.75, 2.13, 6.33.” The records 119 with the business names of returned fields, “Key 7342 Credit 534” and “Key 7342 Coffee Tx 1.75, 2.13, 6.33” are sent by the metadata manager 24 to the real-time retrieval engine 28. The real-time retrieval engine 28 produces a record 121 (e.g., concatenated record), “Key 7342 Credit 534 Coffee Tx 1.75, 2.13, 6.33.”

The on-demand record generator 32 sends a batch request 123 to the batch repository 30. The batch request 123 is keyed for key 7342. The batch repository 30 uses the key in batch request 123 to retrieve key 7342 records 125 the age and children of key 7342 that is sent to the on-demand record generator 32. The batch data included in record 125 does not include the most recent data for the children field. The most recent data for the children field was received at 12:45 pm, which was before request 109 was sent. However, because the children field is a batch field, that field is only updated at pre-determined times, e.g., nightly. At the time that batch request 123 is sent, the nightly batch process has not yet occurred, resulting in the children field being out of date. However, in the context of this example, the fact that the children field is out of date is acceptable, as the fields for which it was important that those fields be current were labeled as real-time fields. The other fields were labeled as batch fields. In labeling these fields as batch fields, a determination was already made that it was not as important that these fields be up-to-date. The on-demand record generator 32 produces a record 50′ (e.g., wide record) as:

| | | | |
|---|---|---|---|
| 7342, | 34 . . . 1 | 534 . . . 1.75, | 2.13, 6.33 |
| Key | Batch Fields | Real-time | Fields |

Record 50′ (e.g., wide record) includes the batch fields, which are out of date as previously discussed. Record 50′ (e.g., wide record) also includes the real-time fields which are current and are up-to-date in real-time, with regard to when request 109 is transmitted. This example illustrates that by pre-specifying which fields are real-time fields and which fields are batch fields, data processing system 20 conserves system resources (e.g., processing resources and memory resources) by not having to continuously generate up-to-date records (e.g., data records) and also by not having to retrieve—in real-time—values for all fields. Rather, at the time of request, the system only has to retrieve values for a subset of fields that will be used by the rule execution engine 34. Those subset of fields are the real-time fields.

This technique is very effective when a record (e.g., real-time data record) is not frequently required, but when a record (e.g., real-time data record) is needed—it is critically important that some fields be up-to-date in real time with regard to when the request is received. As such, these techniques provide for increased computational efficiency for computing records (e.g., real-time records), responsive to a request, because the records do not need to be continuously updated—rather they are only updated when needed.

Additionally, the system described herein generates these records—responsive to a request—when a certain amount of latency (˜1 ms) is acceptable in providing the record. In other examples, no latency is acceptable in producing a record. In these examples where no latency is acceptable, the record (e.g., wide record) has to be updated constantly—even when the record is not being used and the trade off (for constantly updating the records) is increased consumption of processing power and memory resources. However, when this certain amount of latency is acceptable, the system described herein takes advantage of being able to generate the record (e.g., wide record)—with the real-time data retrieved from the operational systems—on demand, which results in improved memory consumption and computational resources (relative to memory consumption and computational resources when a record has to be constantly updated) due to the fact that only information that is actually requested is retrieved from operational systems and used in updating the records (e.g., data records). Additionally, the classification of data fields as being either real-time fields or batch fields—provides for a decreased amount of latency (relative to an amount of latency in retrieving all the data in real-time from operational systems) in generating the record in response to a request. When configuring the system, this classification is done such that data that is very important (e.g., to execution of rules) or data that changes frequently is classified as “real-time” and data that changes less frequently or is less important to real-time decisioning (through execution of rules) is classified as batch. Thus, the techniques described herein reduce latency and memory resources in generating these records (e.g., wide records), while increasing computational efficiency in doing so.

In this case, the rule execution engine 34 executes the business rule
“If Total Value Coffee Transactions in last 24 hours >5, then Send 50 Loyalty Reward Points,”
   for key 7342 and does confirm that key 7342 qualifies for the 50 Loyalty Reward Points offer. The confirmation 127 is sent to the computing system 18 and the computing system 18 generates the offer 129.

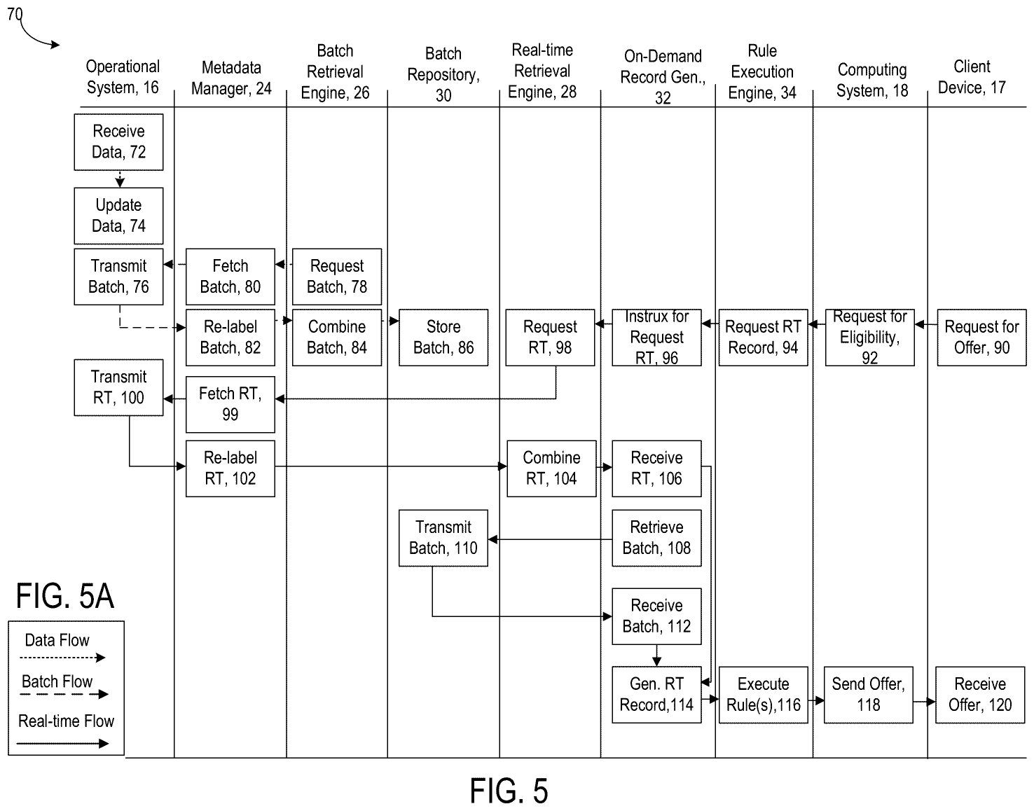

Referring now to FIG. 5A, a legend for FIG. 5 is shown.

Referring now to FIG. 5, a timeline 70 is shown of operations as discussed above. The operational system 16 receives 72 data and updates 74 is records and/or memory and/or databases with the received data. The updated received data is stored in operational system 16. The batch retrieval engine 26 requests 78 batch data (e.g., from the metadata manger 24) and the metadata manager 24 fetches 80 fields names (e.g., source names) of a type==batch from metadata repository 25 (not shown). The metadata manager 24 then transmits to operational system 16 a request for data associated with the fetched source names. The requested data (that is associated with a type==batch) is transmitted 76 by the operational system 16 to the metadata manager 24 that re-labels 82 the fields names of the requested data. For example, a field name of Cns_age is re-labeled to Age. The batch retrieval engine 26 receives the data with the relabeled field names, combines 84 the relabeled batch (e.g., combines the data with the relabeled field names into a single profile or data record), and sends combined, relabeled batch to the batch repository 30, which stores 86 the combined relabeled batch.

In another path, the client device 17 sends 90 a request for offer to the computing system 18. The computing system 18, in response to the request for offer, sends 92 a request for eligibility to the rule execution engine 34. The rule execution engine 34 sends 94 a request for a record (e.g., a RT (real-time) record) to the on-demand record generator 32. The on-demand record generator 32 executes instructions for requesting RT record and sends 96 the request to the real-time retrieval engine 28. The real-time retrieval engine 28 sends 98 a request for RT data to the metadata manager 24. The metadata manager 24 look-up which fields are real-time fields and fetches 99 values for those real-time fields from the operational system 16. The operational system 16, in response to the fetch RT request, transmits 100 RT data to the metadata manager 24, which re-labels 102 RT data (e.g., by updating the technical field names with business field names), and sends the re-labeled RT data to the real-time retrieval engine 28. The real-time retrieval engine 28 combines 104 the RT data, e.g., into a single record. The on-demand record generator 32 receives 106 the combined RT data sends, as a first input, the combined RT data back to the on-demand record generator 32.

In another path, the on-demand record generator 32 also sends 108 a request to retrieve batch data to the batch repository 30. The batch repository 30 transmits 110 batch data (e.g., relabeled, combined batch data) back to the on-demand record generator 32, which receives 112 the batch data as a second input—to be used in generating the record, e.g., the on-demand record. The on-demand record generator 32 generates 114 a record (e.g., RT record) based on the received RT data and the received batch data that were sent, as the first input and the second input—respectively, to the on-demand record generator 32. Based on the generated record 114 (e.g., a RT record), the rule execution engine 34 executes 116 one or more rules. The computing system 18 receives result(s) of the execution of the rule(s), and for rule(s) that successfully qualified for an offer, the computing system 18 sends 118 offer(s) 118, and the client device 17 120 receives offer(s).

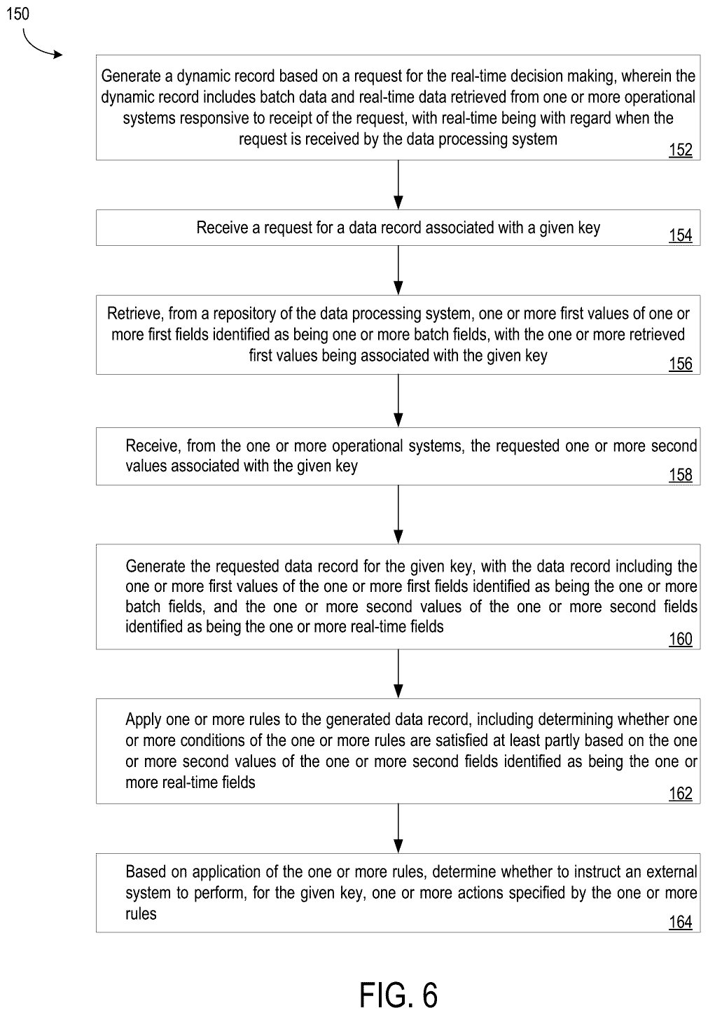

Referring now to FIG. 6, a process 150 executed by the system 10 and, in particular, the data processing system 20 for performing real-time decision-making is shown. The process 150 generates 152 a record (e.g., dynamic record) based on a request for the real-time decisioning. The record (e.g., dynamic record) includes batch data and real-time data retrieved from the operational system 16 in response to receipt of the request, with records (e.g., real-time records) being with regard to when the request is received by the data processing system 20. The process 150 initiates a trigger by receiving 154 a request for a record (e.g., data record) associated with a given key. The process 150 retrieves 156 batch fields that are locally stored in the batch repository 30 of the data processing system 20 having one or more first values of one or more first fields identified as being one or more batch fields, with the one or more retrieved first values being associated with the given key. The process 150 fetches the real-time fields by requesting 158 from the operational system 16, one or more second values of one or more second fields identified as being one or more real-time fields, with the one or more retrieved second values being associated with the given key. The process 150 receives those real-time fields from the operational system 16, with the requested one or more second values associated with the given key.

The process 150 generates 160 the record 50 (e.g., wide record) with the requested record (e.g., data record) for the given key, with the record 50 (e.g., wide record) including the one or more first values of the one or more first fields identified as being the one or more batch fields, and the one or more second values of the one or more second fields identified as being the one or more real-time fields.

The process 150 applies 162 one or more rules to the generated record (e.g., wide data record), including determining whether one or more conditions of the one or more rules are satisfied at least partly based on the one or more second values of the one or more second fields identified as being the one or more real-time fields. The process 150 determines 164 whether to send an offer based on application of the one or more rules and determines whether to instruct an external system to perform, for the given key, one or more actions specified by the one or more rules.

Other aspects of the process 150 include determining, from a metadata repository, that the one or more first fields are identified as being the one or more batch fields (not shown).

Other aspects of the process 150 include responsive to the request, determining, from a metadata repository, that the one or more second fields are identified as being the one or more real-time fields (not shown).

Other aspects of the process 150 include retrieving, from the one or more operational systems, a plurality of values of the one or more first fields identified as being the one or more batch fields, with the plurality of values being associated with a plurality of keys, with the plurality of values including the one or more first values and with the plurality of keys including the given key (not shown).

Other aspects of the process 150 include storing, in the repository of the data processing system, the plurality of values in association with the plurality of keys (not shown).

### Example Computing Environment

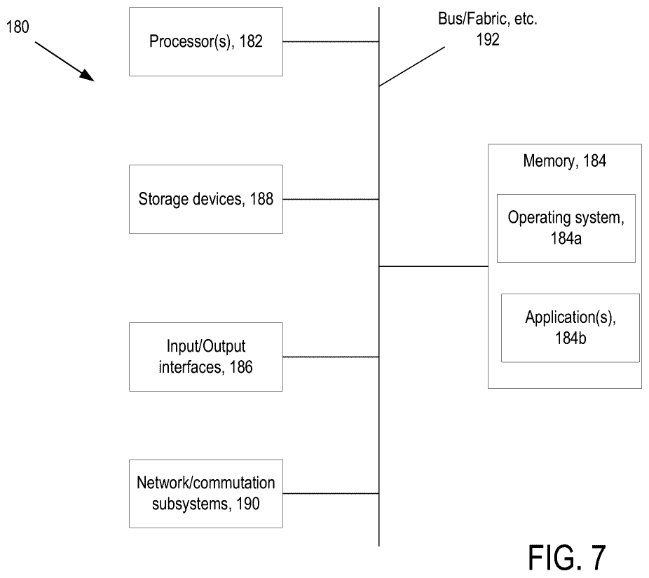

Referring to FIG. 7, an example operating environment for implementing embodiments of the present invention is shown and designated generally as computing device 180. Essential elements of a computing device 180 or a computer or data processing system or client or server are one or more programmable processors 182 for performing actions in accordance with instructions and one or more memory devices 184 for storing instructions and data. Generally, a computer will also include, or be operatively coupled, (via bus 192, fabric, network, etc.,) to I/O components 186, e.g., display devices, network/communication subsystems, etc. (not shown) and one or more mass storage devices 188 for storing data and instructions, etc., and a network communication subsystem 190, which are powered by a power supply (not shown). In memory devices 184 are an operating system 184a and applications 184b for application programming, such as to implement part or all of process 150.

Devices suitable for a computer program product that includes a tangible non-transitory computer storage medium on which are stored computer program instructions and data include all forms of non-volatile memory, media and memory devices including by way of example, semiconductor memory devices (e.g., EPROM, EEPROM, and flash memory devices), magnetic disks (e.g., internal hard disks or removable disks), magneto optical disks, and CD ROM and DVD-ROM disks. The processor and the memory can be supplemented by, or incorporated in, special purpose logic circuitry.

To provide for interaction with a user, embodiments of the subject matter described in this specification are implemented on a computer having a display device (monitor) for displaying information to the user and a keyboard, a pointing device, (e.g., a mouse or a trackball) by which the user can provide input to the computer. In addition, a computer can interact with a user by sending documents to and receiving documents from a device that is used by the user (for example, by sending web pages to a web browser on a user's user device in response to requests received from the web browser).

Embodiments of the subject matter described in this specification can be implemented in a computing system that includes a back end component (e.g., as a data server), or that includes a middleware component (e.g., an application server), or that includes a front end component (e.g., a user computer having a graphical user interface or a Web browser through which a user can interact with an implementation of the subject matter described in this specification), or any combination of one or more such back end, middleware, or front end components. The components of the system can be interconnected by any form or medium of digital data communication (e.g., a communication network). Examples of communication networks include a local area network (“LAN”) and a wide area network (“WAN”), an inter-network (e.g., the Internet), and peer-to-peer networks (e.g., ad hoc peer-to-peer networks).

The computing system can include user devices, e.g., client devices and servers. A client device and server are generally remote from each other and typically interact through a communication network. The relationship of client device and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of any inventions or of what may be claimed, but rather as descriptions of features specific to particular embodiments of particular inventions.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the embodiments described above should not be understood as requiring such separation in all embodiments, and it should be understood that the described program components and systems can generally be integrated together in a single software product or packaged into multiple software products.

A number of embodiments have been described. Nevertheless, it will be understood that various modifications may be made without departing from the spirit and scope of the techniques described herein. For example, some of the steps described above may be order independent, and thus can be performed in an order different from that described. Additionally, any of the foregoing techniques described with regard to a dataflow graph can also be implemented and executed with regard to a program.

Accordingly, other embodiments are within the scope of the following claims.

What is claimed is:

1. A method implemented by a data processing system for performing real-time decisioning by generating a dynamic data record based on a request for the real-time decisioning, wherein the dynamic data record includes batch data and real-time data retrieved from one or more operational systems responsive to receipt of the request, with real-time being with regard to when the request is received by the data processing system, including:
receiving a request for the dynamic data record associated with a given key;
retrieving, from a repository of the data processing system, one or more first values of one or more first fields identified as being one or more batch fields that are retrieved in batch from one or more operational systems, with the one or more retrieved first values being associated with the given key;
in response to receiving the request, requesting, from the one or more operational systems, one or more second values of one or more second fields identified as being one or more real-time fields that are retrieved in real-time from the one or more operational systems, with the requested one or more second values being associated with the given key;
receiving, from the one or more operational systems, the requested one or more second values associated with the given key;
generating the requested data record for the given key, with the data record including:
the one or more first values of the one or more first fields identified as being the one or more batch fields, and
the one or more second values of the one or more second fields identified as being the one or more real-time fields;
applying one or more rules to the generated data record, including determining whether one or more conditions of the one or more rules are satisfied at least partly based on the one or more second values of the one or more second fields identified as being the one or more real-time fields and the one or more first values;
based on application of the one or more rules, determining whether to instruct an external system to perform, for the given key, one or more actions specified by the one or more rules;
writing to memory the generated data record; and
modifying one or more data systems stored in memory with data specifying whether instructions were sent.

2. The method of claim 1, including:
reading, from memory, a table with cells specifying fields as batch fields and fields as real-time fields, and responsive to reading, transmitting one or more signals to one or more operational systems, with the one or more signals specifying requests.

3. The method of claim 1, further including:
determining, from a metadata repository, that the one or more first fields are identified as being the one or more batch fields.

4. The method of claim 1, wherein a batch field is a field that is likely to change with a first frequency and the real-time field is a field that is likely to change with a second frequency which is higher than the first frequency.

5. The method of claim 1, wherein a batch field is a field that is updated intermittently and/or at pre-determined times.

6. The method of claim 1, wherein a real-time field is a field that is updated in real-time.

7. The method of claim 1, wherein the real-time data record is generated only in response to receipt of the request for the dynamic data record.

8. The method of claim 1, wherein the requested one or more second values are received from the operational systems only in response to receipt of the request for the dynamic data record.

9. The method of claim 1, wherein the only data requested and/or received from the operational systems for the generating of the requested data record for the given key is the requested one or more second values being associated with the given key.

10. The method of claim 1, further including:
responsive to the request, determining, from a metadata repository, that the one or more second fields are identified as being the one or more real-time fields.

11. The method of claim 1, further including:
retrieving, from the one or more operational systems, a plurality of values of the one or more first fields identified as being the one or more batch fields, with the plurality of values being associated with a plurality of keys, with the plurality of values including the one or more first values and with the plurality of keys including the given key.

12. The method of claim 1, further including:
storing, in the repository of the data processing system, the plurality of values in association with the plurality of keys.

13. A data processing system for performing real-time decisioning by generating a dynamic data record based on a request for the real-time decisioning, wherein the dynamic data record includes batch data and real-time data retrieved from one or more operational systems responsive to receipt of the request, with real-time being with regard to when the request is received by the data processing system, including:
one or more processing devices, and
one or more machine-readable hardware storage devices storing instructions that are executable by the one or more processing devices to perform operations comprising:
receiving a request for the dynamic data record associated with a given key;
retrieving, from a repository of the data processing system, one or more first values of one or more first fields identified as being one or more batch fields that are retrieved in batch from one or more operational systems, with the one or more retrieved first values being associated with the given key;
in response to receiving the request, requesting, from the one or more operational systems, one or more second values of one or more second fields identified as being one or more real-time fields that are retrieved in real-time from the one or more operational systems, with the requested one or more second values being associated with the given key;
receiving, from the one or more operational systems, the requested one or more second values associated with the given key;
generating the requested data record for the given key, with the data record including:
the one or more first values of the one or more first fields identified as being the one or more batch fields, and
the one or more second values of the one or more second fields identified as being the one or more real-time fields;
applying one or more rules to the generated data record, including determining whether one or more conditions of the one or more rules are satisfied at least partly based on the one or more second values of the one or more second fields identified as being the one or more real-time fields and the one or more first values;
based on application of the one or more rules, determining whether to instruct an external system to perform, for the given key, one or more actions specified by the one or more rules;
writing to memory the generated data record; and
modifying one or more data systems stored in memory with data specifying whether instructions were sent.

14. The data processing system of claim 13, wherein the operations further include:
reading, from memory, a table with cells specifying fields as batch fields and fields as real-time fields, and responsive to reading, transmitting one or more signals to one or more operational systems, with the one or more signals specifying requests.

15. The data processing system of claim 13, wherein the operations further include:
determining, from a metadata repository, that the one or more first fields are identified as being the one or more batch fields.

16. The data processing system of claim 13, wherein a batch field is a field that is likely to change with a first frequency and the real-time field is a field that is likely to change with a second frequency which is higher than the first frequency.

17. The data processing system of claim 13, wherein a batch field is a field that is updated intermittently and/or at pre-determined times.

18. The data processing system of claim 13, wherein a real-time field is a field that is updated in real-time.

19. The data processing system of claim 13, wherein the real-time data record is generated only in response to receipt of the request for the dynamic data record.

20. One or more machine-readable hardware storage devices for performing real-time decisioning by generating a dynamic data record based on a request for the real-time decisioning, wherein the dynamic data record includes batch data and real-time data retrieved from one or more operational systems responsive to receipt of the request, with real-time being with regard to when the request is received by the data processing system, the one or more machine-readable hardware storing devices storing instructions that are executable by one or more processing devices to perform operations including:
receiving a request for the dynamic data record associated with a given key;
retrieving, from a repository of the data processing system, one or more first values of one or more first fields identified as being one or more batch fields that are retrieved in batch from one or more operational systems, with the one or more retrieved first values being associated with the given key;
in response to receiving the request, requesting, from the one or more operational systems, one or more second values of one or more second fields identified as being one or more real-time fields that are retrieved in real-time from the one or more operational systems, with the requested one or more second values being associated with the given key;
receiving, from the one or more operational systems, the requested one or more second values associated with the given key;
generating the requested data record for the given key, with the data record including:
the one or more first values of the one or more first fields identified as being the one or more batch fields, and
the one or more second values of the one or more second fields identified as being the one or more real-time fields;
applying one or more rules to the generated data record, including determining whether one or more conditions of the one or more rules are satisfied at least partly based on the one or more second values of the one or more second fields identified as being the one or more real-time fields and the one or more first values;
based on application of the one or more rules, determining whether to instruct an external system to perform, for the given key, one or more actions specified by the one or more rules;
writing to memory the generated data record; and
modifying one or more data systems stored in memory with data specifying whether instructions were sent.
